(19) United States
(12) Patent Application Publication
(10) Pub. No.: US 2025/0317293 A1
(43) Pub. Date: Oct. 9, 2025

(54) DATA PROCESSING DEVICE AND METHOD FOR OPERATING A DATA PROCESSING DEVICE

(71) Applicant: Robert Bosch GmbH, Stuttgart (DE)

(72) Inventors: Idris Kaya, Sindelfingen (DE); Eugen Becker, Ludwigsburg (DE); Franz Nottensteiner, Reutlingen (DE); Matthias Schreiber, Vaihingen/Enz (DE)

(21) Appl. No.: 19/171,668

(22) Filed: Apr. 7, 2025

(30) Foreign Application Priority Data
Apr. 9, 2024 (DE) 10 2024 203 188.7

(51) Int. Cl. H04L 9/32

(52) U.S. Cl. CPC H04L 9/32

(57) ABSTRACT

A data processing device for a control device. The data processing device has at least a first computing unit and a second computing unit. The first computing unit includes a first memory device, which is configured to provide first data to be sent, a first cryptography unit, which is configured to encrypt the first data to be sent, and a first serial communication interface, which is configured to send the first, encrypted data to be sent from the first computing unit to the second computing unit. The second computing unit includes a second serial, communication interface, which is configured to receive the first, encrypted data from the first computing unit, a second cryptography unit, which is configured to decrypt the first, received, encrypted data, and a second memory device, which is configured to store the first, received, decrypted data.

### FIELD

The present invention relates to a data processing device, a control device and a method for operating a data processing device.

### BACKGROUND INFORMATION

Modern control devices increasingly use two microcontrollers (μC) to provide the required computing power. In order to ensure smooth operation, communication between both controllers is required, which is carried out via the chip-to-chip interface (C2C). This interface offers high bandwidth and low latency. The CPU should be loaded as little as possible and is only used for preparing the data to be transmitted, initiating the transmission and error management in the event of a transmission error. The data transmission itself is carried out autonomously, even for large data blocks, and is unencrypted. There is a risk here that the data stream can be intercepted and, in the worst case, tampered with.

### SUMMARY

The present invention provides a data processing device, a control device, a method, a computer program, and a computer-readable medium.

According to an example embodiment of the present invention, the data processing device comprises at least a first computing unit and a second computing unit. The first computing unit and/or the second computing unit can be designed, for example, as a microcontroller or as a microprocessor.

The first computing unit is equipped with a first memory device, which is configured to provide first data to be sent. Furthermore, the first computing unit has a first cryptography unit, which is configured to encrypt the first data to be sent. In addition, a first, in particular serial, communication interface is provided, which is configured to send the first, encrypted data to be sent from the first computing unit to the second computing unit.

The second computing unit is equipped with a second, in particular serial, communication interface, which is configured to receive the first, encrypted data from the first computing unit. Furthermore, the second computing unit has a second cryptography unit, which is configured to decrypt the first received, encrypted data. In addition, a second memory device is provided, which is configured to store the first received, decrypted data.

The first communication interface and/or the second communication interface can be designed, for example, as a serial communication interface, wherein both communication interfaces can also be regarded as a single communication interface due to their mutual dependence. In particular, the single communication interface can be configured as a chip-to-chip interface (C2C interface) with five lines. These five lines can be one clock line and two data lines per communication direction, wherein the clock is provided by one of the two computing units. The data lines are designed differentially and are used to transmit the user data.

According to an example embodiment of the present invention, the first cryptography unit and/or the second cryptography unit can in particular be designed as a hardware-based cryptography unit. Here, a special hardware component is integrated into the corresponding computing units or microcontrollers, which performs the encryption and decryption processes efficiently and quickly. This hardware unit can support various encryption algorithms, such as AES (Advanced Encryption Standard). Here, this takes advantage of the fact that (symmetric) encryption and decryption algorithms use a fixed block size (e.g., 128 bits in the case of AES) and, depending on the operating mode, encryption and decryption can be carried out block by block—without knowledge of the entire message (e.g., Galois/Counter Mode (GCM)).

The data processing device according to the present invention makes possible, on the one hand, a secure transmission of data between the two computing units, without the risk of the data being intercepted and/or modified during transmission. On the other hand, the use of dedicated cryptography units can ensure that encryption and/or decryption is carried out exclusively on these, in particular hardware-based, units and that no resources of other elements of the computing units, in particular the respective processors, have to be used for this purpose. This means that their computing power can be optimally used for other tasks. In addition, the memory device makes it possible for the received, decrypted data to be stored for further processing steps.

Further advantages of the present invention are disclosed herein.

According to one example embodiment of the present invention, the second memory device is configured to provide second data to be sent. Furthermore, the second cryptography unit is configured to encrypt the second data to be sent. In addition, the second communication interface is configured to send the second, encrypted data to be sent from the second computing unit to the first computing unit.

Furthermore, the first communication interface is configured to receive the second, encrypted data from the second computing unit. The first cryptography unit is configured to decrypt the second, received, encrypted data. In addition, the first memory device is configured to store the second, received, decrypted data.

Due to the provision of the second memory device, the second cryptography unit and the second communication interface, it becomes possible for data to also be securely encrypted by the second computing unit and sent to the first computing unit. The first computing unit is capable of receiving, decrypting and storing these data in the first memory device. As a result, secure communication between both computing units can be ensured.

According to a further example embodiment of the present invention, the first memory device is configured to temporarily store the first, encrypted data to be sent prior to sending. Alternatively or additionally, the first memory device can be configured to temporarily store the second, encrypted data received from the second computing unit prior to decryption.

Alternatively or additionally, the second memory device can be configured to temporarily store the second, encrypted data to be sent prior to sending. Alternatively or additionally, the second memory device can be configured to temporarily store the first, encrypted data received from the first computing unit prior to decryption.

Due to the provision of the temporary storage of the encrypted data prior to transmission and/or prior to decryption, an additional layer of security is created. As a result, possible transmission errors or other disruptions during communication between the computing units can be intercepted and corrected. The temporary storage thus makes possible a reliable and error-free transmission of data between the computing units.

According to a further aspect of the present invention, the first memory device is configured to store the first unencrypted data to be sent and the first encrypted data to be sent in different areas in the first memory device. Alternatively or additionally, the second memory device is configured to store the first received encrypted data and the first received unencrypted data in different areas in the second memory device. Due to this arrangement, efficient data management is made possible and a clear separation between unencrypted and encrypted data is ensured.

According to a further aspect of the present invention, the first communication interface is configured to send a set of first data to be encrypted and sent only if the set has been completely encrypted by the first cryptography unit. Alternatively or additionally, the second cryptography unit is configured to decrypt a set of first data to be decrypted and received only if the set has been completely received by the second communication interface. Due to this arrangement, it is ensured that data integrity is maintained and that no incomplete or incorrect data are transmitted or processed.

According to a further aspect of the present invention, the second communication interface is configured to send a set of second data to be encrypted and sent only if the set has been completely encrypted by the second cryptography unit. Alternatively or additionally, the first cryptography unit is configured to decrypt a set of second data to be decrypted and received only if the set has been completely received by the first communication interface. Due to this arrangement, it is likewise ensured that data integrity is maintained and that no incomplete or incorrect data are transmitted or processed.

According to a further embodiment of the present invention, the first cryptography unit comprises a first cryptography module and a second cryptography module. Alternatively or additionally, the second cryptography unit may comprise a third cryptography module and a fourth cryptography module. The first cryptography module and the third cryptography module are configured to encrypt the data to be sent. The second cryptography module and the fourth cryptography module, on the other hand, are configured to decrypt the data to be received.

This makes possible a secure data transmission between the first computing unit and the second computing unit through the use of cryptography units and cryptography modules. Due to the encryption of the data to be sent and the decryption of the data to be received, increased data security is ensured. In particular, this ensures the secure use of the method in full duplex mode.

The aforementioned advantages also apply correspondingly to a control device that comprises at least one data processing device according to one of the above-described embodiments. The control device thus comprises a first computing unit and a second computing unit. The first computing unit is equipped with a first memory device, which is configured to provide first data to be sent. Furthermore, the first computing unit has a first cryptography unit, which is configured to encrypt the first data to be sent. In addition, a first, in particular serial, communication interface is provided, which is configured to send the first, encrypted data to be sent from the first computing unit to the second computing unit.

The second computing unit is equipped with a second, in particular serial, communication interface, which is configured to receive the first, encrypted data from the first computing unit. Furthermore, the second computing unit has a second cryptography unit, which is configured to decrypt the first, received, encrypted data. In addition, a second memory device is provided, which is configured to store the first, received, decrypted data.

The aforementioned advantages also apply correspondingly to a method for operating a data processing device, in particular according to one of the above-described embodiments of the present invention, in particular for a control device according to the above-described embodiment. According to an example embodiment of the present invention, the method comprises the following steps:
Providing first data to be sent by means of a first memory device.
Encrypting the first data to be sent by means of a first cryptography unit.
Sending the first, encrypted data by means of a first, in particular serial, communication interface.
Receiving first, encrypted data by means of a second, in particular serial, communication interface.
Decrypting the first, received, encrypted data by means of a second cryptography unit.
Storing the first, received, decrypted data by means of a second memory device.

This method offers two key advantages. Firstly, it makes the secure transmission of data possible between the two computing units, without the risk of the data being intercepted or tampered with during transmission. Secondly, the use of dedicated cryptography units ensures that encryption and decryption are performed exclusively on these special, in particular hardware-based, units. As a result, it is avoided that resources of other elements of the computing units, in particular the respective processors, have to be used for these tasks. This makes the optimal use of computing power for other tasks possible. In addition, the memory device offers the possibility of storing the received, decrypted data for further processing steps.

According to a further example embodiment of the present invention, the method comprises the following steps:
Providing second data to be sent by means of the second memory device;
Encrypting the second data to be sent by means of the second cryptography unit;
Sending the second, encrypted data by means of the second communication interface; and/or
Receiving second, encrypted data by means of the first communication interface;
Decrypting the second, received, encrypted data by means of the first cryptography unit; and
Storing the second, received, decrypted data by means of the first memory device.

According to a further embodiment of the present invention, it can be provided that the first memory device temporarily stores the first, encrypted data to be sent prior to sending and/or temporarily stores the second, encrypted data received from the second computing unit prior to decryption and/or that the second memory device temporarily stores the second encrypted data to be sent prior to sending and/or temporarily stores the first, encrypted data received from the first computing unit prior to decryption.

According to a further embodiment of the present invention, it can be provided that the first memory device stores the first, unencrypted data to be sent and the first, encrypted data to be sent in different areas in the first memory device and/or the second memory device stores the first, received, encrypted data and the first, received, unencrypted data in different areas in the second memory device. Due to the separate storage of unencrypted and encrypted data in different areas of the memory devices, a clear separation and organization of the data is made possible. This facilitates processing and access to the data both during sending and receiving.

The separate storage of unencrypted and encrypted data can be achieved, for example, by using different memory areas or memory addresses in the memory device. As a result, it is ensured that the data are not mixed or confused and that they can be correctly assigned at all times.

The separate storage of the received, encrypted and unencrypted data in different areas of the second memory device makes the simple and efficient processing of the data possible. The data can be retrieved from the corresponding memory areas and further processed as required.

This contributes to the security and integrity of the data and makes smooth communication possible between the various components of the control device or between the control device and external devices.

According to a further aspect of the present invention, the first communication interface sends a set of first data to be encrypted and sent only if the set of first data to be encrypted and sent has been completely encrypted by the first cryptography unit. Alternatively or additionally, the second cryptography unit only decrypts a set of first, received data to be decrypted if the set of first, received data to be decrypted has been completely received by the second communication interface. Due to these measures, it is ensured that data integrity is maintained and that no incomplete or incorrect data are transmitted or processed.

According to a further aspect of the present invention, the sending of a set of second data to be encrypted and sent via the second communication interface is only carried out if the set of second data has been completely encrypted by the second cryptography unit. As a result, it is ensured that the data are fully encrypted during transmission and that no unencrypted data are transmitted.

Alternatively or additionally, the decryption of a set of second, received data to be decrypted is carried out by the first cryptography unit only if the set of second data has been completely received by the first communication interface. As a result, it is ensured that the data are complete before they are decrypted, in order to ensure correct recovery of the original data.

The aforementioned advantages also apply correspondingly to a computer program comprising instructions that, when the computer program is executed by a computer or by a data processing device according to one of the above-described exemplary embodiments or by a control device according to a above-described exemplary embodiment, cause the latter to carry out at least one of the steps of the method according to one of the above-described exemplary embodiments.

The present invention also relates to a computer-readable medium on which the computer program is stored.

### BRIEF DESCRIPTION OF THE DRAWINGS

Exemplary embodiments of the present invention are illustrated schematically in the figures and explained in more detail in the following description. The same reference signs are used for the elements which are shown in the various figures and act similarly, wherein a repeated description of the elements is dispensed with.

### BRIEF DESCRIPTION OF THE DRAWINGS

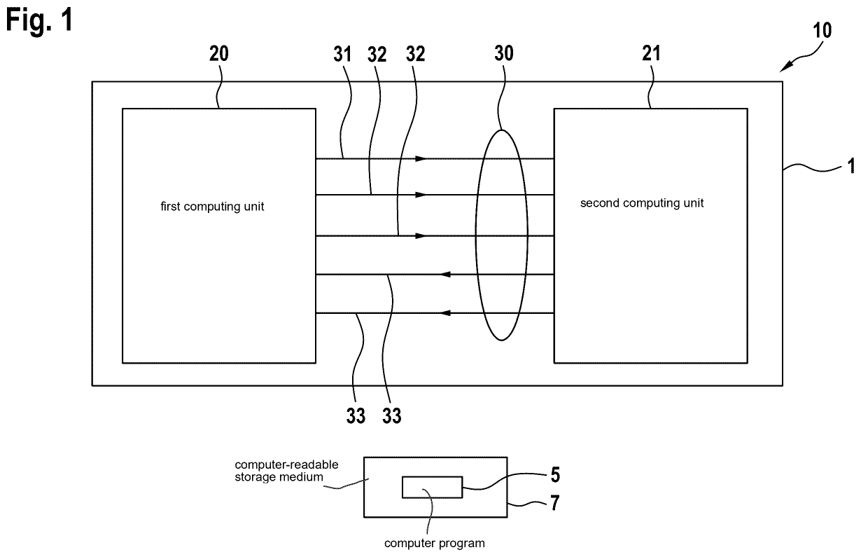

FIG. 1 is a schematic representation of a data processing device according to an exemplary embodiment of the present invention.

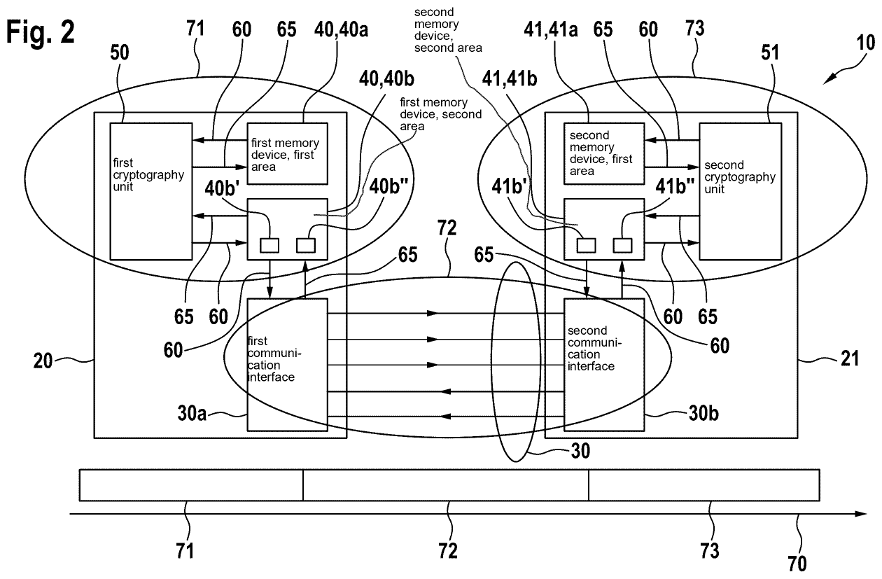

FIG. 2 is a schematic representation of a data processing device according to a further exemplary embodiment of the present invention.

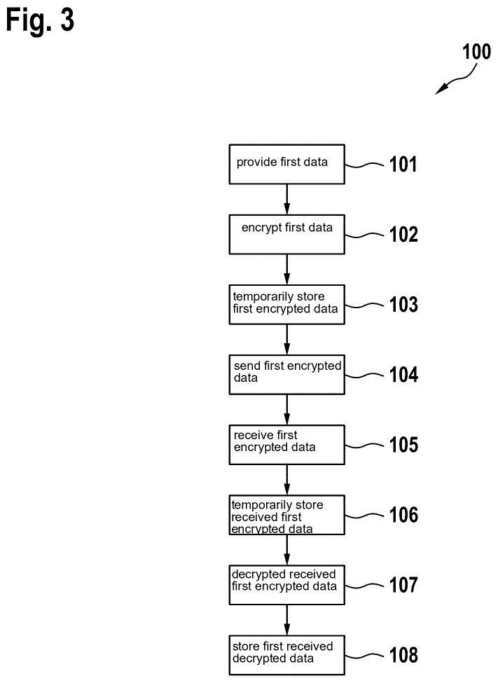

FIG. 3 is a schematic representation of a method according to an embodiment example of the present invention.

### DETAILED DESCRIPTION OF EXAMPLE EMBODIMENTS

As explained above, the present invention describes a data processing device, a method for operating a data processing device, a control device, a computer program and a computer-readable medium, which make it possible to protect data transmission between two computing units against interception and/or tampering in a resource-saving manner.

FIG. 1 illustrates, according to an exemplary embodiment of the present invention, a data processing device 10 that comprises a first computing unit 20 and a second computing unit 21. The computing units 20, 21 can be, for example, microcontrollers or microprocessors that are connected for signal or data purposes via a communication interface 30, for example via a chip-to-chip interface (C2C). The communication interface 30 comprises 5 lines: a clock line 31, which is provided by one of the two computing units 20, 21, along with two parallel data lines 32 from the first computing unit 20 to the second computing unit 21 and two parallel data lines 33 from the second computing unit 21 to the first computing unit 20. It can be provided here that a full duplex mode, i.e., the simultaneous transmission of data from the first computing unit 20 to the second computing unit 21 and of data from the second computing unit 21 to the first computing unit 20, is made possible. The data processing device 10 can, for example, be arranged on or in a control device 1, in particular for a vehicle.

Furthermore, FIG. 1 shows a computer program 5 that is stored on a computer-readable storage medium 7 and, when executed by a computer or by the data processing device 10, causes the computer or the data processing device to carry out the steps of the method 100 according to FIG. 3.

In FIG. 2, the data processing device 10 from FIG. 1 is shown again in more detail. Here, the individual components of the computing units 20, 21 are explained in more detail below. The first computing unit 20 has a first memory device 40, a first cryptography unit 50 and a first communication interface 30a. The second computing unit 21 has a second memory device 41, a second cryptography unit 51 and a second communication interface 30b. Here, the first communication interface 30a and the second communication interface 30b can be configured as a serial interface and/or can interact in such a way that they form the communication interface 30 as explained in FIG. 1.

The first memory device 40 is configured to provide the first cryptography unit 50 with first data 60 to be sent. The first cryptography unit 50 encrypts the first data 60 to be sent and forwards the first, encrypted data 60 to be sent to the first communication interface 30a, which sends the first, encrypted data 60 to be sent to the second communication interface 30b. For example, the transmission of the first data 60 can be carried out in certain block sizes. A block size can be, for example, 1 kB and can be varied up or down depending on the latency requirement. In particular, it can be provided that a transmission of the first data 60 from the first computing unit 20 to the second computing unit 21 only begins if the first data 60 or a previously defined data block is completely encrypted.

It can be provided that the first memory unit 40 is configured to temporarily store the first, encrypted data 60 to be sent prior to sending. Preferably, it can be provided that the first memory unit 40 temporarily stores the first, encrypted data 60 to be sent in a second area 40b, which is different from a first area 40a in which the first data 60 to be sent are present.

The second communication interface 30b is configured to receive the first, encrypted data 60 and forward them to the second cryptography unit 51. The second cryptography unit 51 is configured to decrypt the first, received, encrypted data 60. The second memory device 41 is configured to store the first, received, decrypted data 60.

In particular, it can be provided that decryption of the first data 60 by the second cryptography unit 51 only begins if the first data 60 or a previously defined data block has been completely received by the second computing unit 21.

It can be provided that the second memory unit 41 is configured to temporarily store the first, received, encrypted data 60 prior to decryption. Preferably, it can be provided that the second memory unit 41 temporarily stores the first, received, encrypted data 60 in a second area 41b, which is different from a first area 41a in which the first, received, decrypted data 60 are present.

Alternatively or additionally, it can be provided that the second memory device 41 is configured to provide the second cryptography unit 51 with second data 65 to be sent. The second cryptography unit 51 encrypts the second data 65 to be sent and forwards the second, encrypted data 65 to be sent to the second communication interface 30b, which sends the second, encrypted data 65 to be sent to the first communication interface 30a.

In particular, it can be provided that a transmission of the second data 65 from the second computing unit 21 to the first computing unit 20 only begins if the second data 65 or a previously defined data block is completely encrypted.

Optionally, it can be provided that the second memory unit 41 is configured to temporarily store the second, encrypted data 65 to be sent prior to sending. Preferably, it can be provided that the second memory unit 41 temporarily stores the second, encrypted data 65 to be sent in the second area 41b, which is different from the first area 41a in which the second data 65 to be sent are present. Particularly preferably, it can be provided that the second memory unit 41 stores the second, encrypted data 65 to be sent in a first sub-area 41b′ of the second area 41b, which is different from a second sub-area 41b″ of the second area 41b, in which the first, received, encrypted data 60 are temporarily stored.

Alternatively or additionally, it can be particularly preferably provided that the first memory unit 40 stores the first, encrypted data 60 to be sent in a first sub-area 40b′ of the second area 40b, which is different from a second sub-area 40b″ of the second area 40b, in which the first, received, encrypted data 65 are temporarily stored.

Optionally, it can be provided that the first communication interface 30a is configured to receive the second, encrypted data 65 and to forward them to the first cryptography unit 50. The first cryptography unit 50 is configured to decrypt the second, encrypted data 65. The first memory device 40 is configured to store the second, received, decrypted data 65.

In particular, it can be provided that decryption of the second data 65 by the first cryptography unit 50 only begins if the second data 65 or a previously defined data block has been completely received by the first computing unit 20.

Optionally, it can be provided that the first memory unit 40 is configured to temporarily store the second, received, encrypted data 65 prior to decryption. Preferably, it can be provided that the first memory unit 40 temporarily stores the second, received, encrypted data 65 in the second area 40b, which is different from the first area 40a in which the second, received, decrypted data 65 are present. Particularly preferably, it can be provided that the first memory unit 40 stores the second, received, encrypted data 65 in a first sub-area 40b′ of the second area 40b, which is different from a second sub-area 40b″ of the second area 40b, in which the first, encrypted data 60 to be sent are temporarily stored.

The sequential nature of these processes is further illustrated based on the timeline 70 based on the first data 60 in FIG. 2. Initially, the encryption 71 of the first data 60 is carried out. As soon as the encryption 71 is completed, a transmission 72 of the first data 60 is carried out from the first computing unit 20 to the second computing unit 21. As soon as the transmission 72 is completed, a decryption 73 of the first data 60 is carried out.

FIG. 3 is a schematic representation of a method 100 according to an exemplary embodiment. Here, data 60 are sent from a first computing unit 20 to a second computing unit 21 and alternatively or additionally received by the latter. According to a first method step 101, a provision of the first data 60 to be sent can be carried out by means of a first memory device 40. According to a second method step 102, an encryption of the first data 60 to be sent can be carried out by means of a first cryptography unit 50. Optionally, in a third method step 103, temporary storage can be carried out, in which the first memory device 40 temporarily stores the first, encrypted data 60 to be sent prior to sending. According to a fourth method step 104, a sending of the first, encrypted data 60 can be carried out by means of a first, in particular serial, communication interface 30a.

Alternatively or additionally, according to a fifth method step 105, a reception of the first, encrypted data 60 can be carried out by means of a second, in particular serial, communication interface 30b. Optionally, in a sixth method step 106, temporary storage can be carried out, in which a second memory device 41 temporarily stores the first, encrypted data 60 received from the first computing unit 20 prior to decryption. According to a seventh method step 107, a decryption of the first, received, encrypted data 60 can be carried out by means of the second cryptography unit 51. According to an eighth method step 108, a storage of the first, received, decrypted data 60 can be carried out by means of the second memory device 41.

Alternatively or additionally, the method (not additionally shown) can also take place in the opposite direction, wherein data 65 are sent from the second computing unit 21 to the first computing unit 20 and alternatively or additionally received by the latter. In particular, the sending of the data 60 from the first computing unit 20 to the second computing unit 21 or the reception of the data 60 by the second computing unit 21 along with the sending of the data 65 from the second computing unit 21 to the first computing unit 20 or the reception of the data 65 by the first computing unit 20 can be carried out simultaneously or in full duplex mode. For this purpose, it can be provided that the first cryptography unit 50 comprises a first cryptography module in order to encrypt the data 60 to be sent and a second cryptography module to decrypt the data 65 to be received, and the second cryptography unit comprises a third cryptography module in order to encrypt the data 65 to be sent and a fourth cryptography module to decrypt the data 60 to be received.

According to the following steps (not shown), in the first method step, a provision of second data 65 to be sent can be carried out by means of the second memory device 41. According to a second method step, an encryption of the second data 65 to be sent can be carried out by means of the second cryptography unit 51. In a third step, temporary storage can be carried out, in which the second memory device 41 temporarily stores the second, encrypted data 65 to be sent prior to sending. According to a fourth method step, a sending of the second, encrypted data 65 can be carried out by means of the second, in particular serial, communication interface 30b.

Alternatively or additionally, according to a fifth method step, a reception of the second, encrypted data 65 can be carried out by means of the first, in particular serial, communication interface 30a. In a sixth step, temporary storage can be carried out, in which the first memory device 40 temporarily stores the second, encrypted data 65 received from the second computing unit 21 prior to decryption. According to a seventh method step, a decryption of the second, received, encrypted data 65 can be carried out by means of the first cryptography unit 50. According to an eighth method step, a storage of the second, received, decrypted data 65 can be carried out by means of the first memory device 40.

1-16. (canceled)

17. A data processing device for a control device, the data processing device comprising:
at least a first computing unit and a second computing unit;
wherein the first computing unit includes a first memory device configured to provide first data to be sent, a first cryptography unit configured to encrypt the first data to be sent, and a first serial communication interface configured to send the encrypted first data to be sent from the first computing unit to the second computing unit; and
wherein the second computing unit includes a second serial communication interface configured to receive the encrypted first data from the first computing unit, a second cryptography unit configured to decrypt the received encrypted first data, and a second memory device which is configured to store the decrypted received first data.

18. The data processing device according to claim 17, wherein the second memory device is configured to provide second data to be sent, the second cryptography unit is configured to encrypt the second data to be sent, and the second communication interface is configured to send the encrypted second data to be sent from the second computing unit to the first computing unit, wherein the first communication interface is configured to receive the encrypted second data from the second computing unit, the first cryptography unit is configured to decrypt the received encrypted second data, and the first memory device is configured to store the decrypted received second data.

19. The data processing device according to claim 18, wherein the first memory device is configured to temporarily store the encrypted first data to be sent prior to sending and/or to temporarily store the encrypted second data received from the second computing unit prior to decryption and/or the second memory device is configured to temporarily store the encrypted second data to be sent prior to sending and/or to temporarily store the encrypted first data received from the first computing unit prior to decryption.

20. The data processing device according to claim 17, wherein the first memory device is configured to store the unencrypted first data to be sent and the encrypted first encrypted data to be sent in different areas in the first memory device and/or the second memory device is configured to store the received encrypted first data and the unencrypted received first data in different areas in the second memory device.

21. The data processing device according to claim 17, wherein the first communication interface is configured to send a set of first data to be encrypted and sent only when the set of first data to be encrypted and sent has been completely encrypted by the first cryptography unit and/or the second cryptography unit is configured to decrypt a received set of first data to be decrypted only when the received set of first data to be decrypted has been completely received by the second communication interface.

22. The data processing device according to claim 18, wherein the second communication interface is configured to send a set of second data to be encrypted and sent only when the set of second data to be encrypted and sent has been completely encrypted by the second cryptography unit and/or the first cryptography unit is configured to decrypt a received set of second data to be decrypted only when the received set of second data to be decrypted has been completely received by the first communication interface.

23. The data processing device according to claim 18, wherein the first cryptography unit includes a first cryptography module and a second cryptography module and/or the second cryptography unit includes a third cryptography module and a fourth cryptography module, wherein the first cryptography module and the third cryptography module are configured to encrypt data to be sent and the second cryptography module and the fourth cryptography module are configured to decrypt data to be received.

24. A control device, comprising:
at least one data processing device including:
at least a first computing unit and a second computing unit,
wherein the first computing unit includes a first memory device configured to provide first data to be sent, a first cryptography unit configured to encrypt the first data to be sent, and a first serial communication interface configured to send the encrypted first data to be sent from the first computing unit to the second computing unit, and
wherein the second computing unit includes a second serial communication interface configured to receive the encrypted first data from the first computing unit, a second cryptography unit configured to decrypt the received encrypted first data, and a second memory device which is configured to store the received decrypted first data.

25. A method for operating a data processing device, the data processing device including at least a first computing unit and a second computing unit, wherein the first computing unit includes a first memory device configured to provide first data to be sent, a first cryptography unit configured to encrypt the first data to be sent, and a first serial communication interface configured to send the encrypted first data to be sent from the first computing unit to the second computing unit, and wherein the second computing unit includes a second serial communication interface configured to receive the encrypted first data from the first computing unit, a second cryptography unit configured to decrypt the received encrypted first data, and a second memory device which is configured to store the received decrypted first data, the method comprising the following steps:
performing:
(i) providing the first data to be sent using the first memory device,
encrypting the first data to be sent using the first cryptography unit, and
sending the encrypted first data using a first serial communication interface; and/or
(ii) receiving the first encrypted data using the second serial communication interface,
decrypting the received first encrypted data using a second cryptography unit, and
storing the decrypted received first data using a second memory device.

26. The method according to claim 25, further comprising the following steps:
performing:
(i) providing second data to be sent using the second memory device,
encrypting the second data to be sent using the second cryptography unit,
sending the encrypted second data using the second communication interface; and/or
(ii) receiving second encrypted data using the first communication interface,
decrypting the received second encrypted data using the first cryptography unit, and
storing the decrypted received second data using the first memory device.

27. The method according to claim 26, wherein: (i) the first memory device temporarily stores the encrypted first data to be sent prior to sending and/or temporarily stores the encrypted second data received from the second computing unit prior to decryption and/or the second memory device temporarily stores the encrypted second data to be sent prior to sending and/or temporarily stores the encrypted first data received from the first computing unit prior to decryption.

28. The method according to claim 25, wherein the first memory device stores the unencrypted first data to be sent and the encrypted first data to be sent in different areas in the first memory device and/or the second memory device stores the received encrypted first data and the unencrypted received first data in different areas in the second memory device.

29. The method according to claim 25, wherein: (i) the first communication interface sends a set of first data to be encrypted and sent only when the set of first data to be encrypted and sent has been completely encrypted by the first cryptography unit and/or (ii) the second cryptography unit decrypts a received set of first data to be decrypted only when the received set of first data to be decrypted has been completely received by the second communication interface.

30. The method according to claim 26, wherein: (i) the second communication interface sends a set of second data to be encrypted and sent only when the set of second data to be encrypted and sent has been completely encrypted by the second cryptography unit and/or (ii) the first cryptography unit decrypts a received set of second data to be decrypted only when the received set of second data to be decrypted has been completely received by the first communication interface.

31. A non-transitory computer-readable medium on which is stored a computer program for operating a data processing device, the data processing device including at least a first computing unit and a second computing unit, wherein the first computing unit includes a first memory device configured to provide first data to be sent, a first cryptography unit configured to encrypt the first data to be sent, and a first serial communication interface configured to send the encrypted first data to be sent from the first computing unit to the second computing unit, and wherein the second computing unit includes a second serial communication interface configured to receive the encrypted first data from the first computing unit, a second cryptography unit configured to decrypt the received encrypted first data, and a second memory device which is configured to store the received decrypted first data, the computer program, when executed by the data processing device, causing the data processing device to perform the following steps:
performing:
(i) providing the first data to be sent using the first memory device,
encrypting the first data to be sent using the first cryptography unit, and
sending the encrypted first data using a first serial communication interface; and/or
(ii) receiving the first encrypted data using the second serial communication interface,
decrypting the received first encrypted data using a second cryptography unit, and
storing the decrypted received first data using a second memory device.
